(19) United States
(12) Patent Application Publication
(10) Pub. No.: US 2008/0013165 A1
(43) Pub. Date: Jan. 17, 2008

(54) Deep UV telecentric imaging system with axisymmetric birefringent element and polar-orthogonal polarization

(76) Inventor: James Edson Webb, Fairport, NY (US)

Correspondence Address: CORNING INCORPORATED, SP-TI-3-1, CORNING, NY, 14831, US

(21) Appl. No.: 11/498,639

(22) Filed: Aug. 3, 2006

Related U.S. Application Data
(60) Provisional application No. 60/595,765, filed on Aug. 3, 2005.

(51) Int. Cl. G02B 27/28; G02B 13/14

(52) U.S. Cl. 359/352; 359/494; 359/500

(57) ABSTRACT

Axisymmetric birefringent materials are incorporated into a deep UV imaging system by exploiting axial symmetries. A polar orthogonal polarization pattern is relayed conjugate to a pupil of a telecentric imaging system to avoid birefringence of axisymmetric birefringent optics located in telecentric object or image space.

### TECHNICAL FIELD

The invention relates to imaging systems for deep ultraviolet light, particularly imaging systems requiring high resolution, such as microlithographic projection systems focusing the deep ultraviolet light through high numerical apertures.

### BACKGROUND OF THE INVENTION

The drive for writing smaller and smaller features by microlithographic projection has led to the use shorter wavelengths of light, now in the deep ultraviolet (UV) range, and to the use of higher numerical aperture systems, now much greater than one for the shorter wavelengths. Resolution, which is generally regarded as the smallest resolvable distance between two objects, is a function of wavelength divided by numerical aperture.

Current projection systems operating at deep UV wavelengths below 300 nanometers face many problems, including very limited material choices from which to construct optical elements. Optical materials are disqualified for a number of reasons including inadequate transmissivity, susceptibility to damage due to high photon energies, and anisotropies exposed by the shorter wavelengths.

Even the two currently favored materials, fused silica and calcium fluoride, experience problems. Fused silica is subject to various expansions and contractions in different energy regimes and can be progressively damaged at higher power (photon) densities. For example, fused silica can also undergo a phenomenon referred to as “compaction” where irradiated portions of the fused silica material both increase in refractive index and decrease in volume. Stresses within the fused silica optical elements, particularly larger diameter fused silica elements, can produce birefringence. Calcium fluoride scatters some light and requires protection from melting at the higher power densities. Although calcium fluoride has a cubic crystal structure, calcium fluoride exhibits intrinsic birefringence at the shorter wavelengths, which requires correction. The two favored materials, fused silica and calcium fluoride, differ only slightly in refractive index and, therefore, provide limited opportunities for correcting aberrations. High power densities, such as those close to the image plane of the reducing systems, are particularly difficult to accommodate using either material.

Birefringence correcting elements have been used to compensate for both stress-induced birefringence and intrinsic birefringence of optical elements within deep UV imaging systems. Generally, the birefringence correcting elements exhibit a negative form of the birefringence exhibited collectively by the other optical elements. Materials that exhibit a substantial natural birefringence, including uniaxial crystals such as sapphire, can be used to make the corrections. The higher natural birefringence enables the correcting elements to be much thinner, which can reduce ray-splitting effects that accompany the correction.

### SUMMARY OF INVENTION

The invention in its preferred form incorporates optical materials into a deep UV imaging system that would otherwise be excluded by their natural birefringence from participating in the imaging function. The optical materials include uniaxial crystals, such as sapphire, that have previously been used as birefringence compensators and whose forms have been governed by the requirements of the birefringence correction. A combination of symmetries is exploited in accordance with the invention to avoid adverse effects of the birefringence, enabling more durable and higher index optical materials to form optical elements at key positions of the deep UV imaging system. For example, uniaxial crystal materials can be used to form the “first glass” or “last glass” of a deep UV imaging system. The increased durability of the preferred materials withstands higher power densities, particularly the high power densities adjacent to image planes of reducing systems. The higher index of the preferred materials contributes to higher numerical apertures of the imaging systems or to smaller sized optical systems of a given numerical aperture. The higher index of the preferred materials can also contribute to reducing aberrations.

A combination of three symmetries is preferably exploited in accordance with the invention to expand the range of optical materials that can participate in the image function of deep UV imaging systems. The additional optical materials are preferably crystals exhibiting axial birefringence symmetry, which is the first of the three symmetries exploited by the invention. The second of the three symmetries is a polar-orthogonal polarization of the UV light. The third of the three symmetries is a telecentric ray configuration for aligning the polar-orthogonal polarization of the UV light with the axial birefringence symmetry of the additional materials.

Although the birefringence of the preferred additional materials, such as uniaxial crystals, can vary with the inclination of rays to the optical axis of the materials, the birefringence is preferably invariant with the angular position of the rays around the optical axis. Robust high-index crystal materials, such as sapphire, can be used despite their higher birefringence because their birefringence exhibits an axial symmetry. Other crystal materials exhibiting radial birefringence symmetries can be clocked or otherwise combined to exhibit collective axial birefringence symmetry. One or more optical elements exhibiting axisymmetric birefringence are incorporated into the preferred deep UV imaging systems of the invention.

The polar-orthogonal polarization preferred for the invention takes the form of radial or azimuthal polarization. For a given cone of light propagating along an optical axis, the electric field vectors of radially polarized rays lie in the axial planes of their rays, and the electric field vectors of azimuthally polarized rays extend perpendicular to the same axial planes. Radial polarization can be equated to so-called “TM” polarization on a ray-by-ray basis because the electric field vectors tip with inclinations of their rays in the individual axial planes. Azimuthal polarization can be equated to so-called “TE” polarization on a ray-by-ray basis because the electric field vectors do not tip in any different direction with inclinations of their rays in the individual axial planes.

The telecentric ray configuration allows the polar-orthogonal polarization to be projected through the imaging system in alignment with the optical axis of an optic exhibiting axially symmetric birefringence. The axially symmetric polarization pattern can be formed conjugate to the pupil of a telecentric imaging system, so that within telecentric image or object space, each object or image point is associated with its own cone of light having an axis formed by a chief ray that extends parallel to both the optical axis of the polar-orthogonal polarization and the axially symmetric birefringence. Accordingly, each object or image cone in telecentric space exhibits substantially the same polar-orthogonal polarization pattern in alignment with (i.e., parallel to) the axis of the axially symmetric birefringent material.

The confluence of the three symmetries obviates the birefringent effects of the axisymmetric birefringent optics. Ideally, the polarized light propagates through the axisymmetric birefringent optics as either extraordinary or ordinary rays but not both. Accordingly, the axially symmetric birefringent material can be highly birefringent without deleteriously affecting imaging as a result of its birefringence. The axisymmetric birefringent optics can serve a number of purposes within the deep UV imaging systems, including those related to imaging such as increasing the numerical aperture of the system or reducing the size of systems with a given numerical aperture. Refractive index disparities made possible by the additional material choices can be used to reduce aberrations. Additional materials having higher durability can be used to better withstand high power densities, such as found at the image plane of reducing systems.

One version of the invention can be described succinctly as a telecentric imaging system aligning polar-orthogonally polarized light with an axisymmetric birefringent element. Preferably, the polar-orthogonally polarized light has a polarization axis about which electric field vectors are symmetrically arranged, the axisymmetric birefringent element has a birefringence axis about which birefringence is symmetrically arranged, and the polarization axis of the polar-orthogonally polarized light is aligned with the birefringence axis of the axisymmetric birefringent element.

The axisymmetric birefringent element is preferably located within a telecentric space in which chief rays of object or image points are aligned with both the polarization axis of the polar-orthogonally polarized light and the birefringence axis of the axisymmetric birefringent element. The telecentric imaging system can be a reducing system, and the axisymmetric birefringent element can be located within telecentric image space. The axisymmetric birefringent element is preferably formed at least in part of sapphire.

The birefringent element separates polarized rays into extraordinary and ordinary rays, and the polar-orthogonally polarized light transmits through the-axisymmetric birefringent element as substantially one or the other of the extraordinary and ordinary rays. The axisymmetric birefringent element preferably exhibits a birefringence difference between ordinary and extraordinary rays of at least 0.0005.

The polar-orthogonally polarized light can be azimuthally polarized, which transmits through the axisymmetric birefringent element as ordinary rays, or radially polarized, which transmits through the axisymmetric birefringent element as extraordinary rays. The axisymmetric birefringent element can exhibit a refractive index that varies with inclinations of the extraordinary rays producing a wavefront alteration that compensates for one or more other wavefront alterations of the telecentric imaging system. The axisymmetric birefringent element can also contribute optical power to the telecentric optical system and increase a numerical aperture of the telecentric imaging system. In this latter regard, the axisymmetric birefringent element is preferably a solid optical element that exhibits an average refractive index that is higher than other solid optical elements of the telecentric imaging system.

Another version of the invention as a deep UV imaging system includes an arrangement of optical elements for forming an image of an object and an illuminator that produces deep UV polar-orthogonally polarized light. At least one of the optical elements is an axisymmetric birefringent element exhibiting a birefringence difference between ordinary and extraordinary rays. The axisymmetric birefringent element is oriented with respect to the polar-orthogonally polarized light such that the polar-orthogonally polarized light propagates through the axisymmetric birefringent element as substantially one or the other of the ordinary and extraordinary rays.

Preferably, the illuminator produces the polar-orthogonally polarized light substantially conjugate to a pupil of the imaging system. The axisymmetric birefringent element is preferably located in a telecentric space in which chief rays of object or image points extend substantially parallel to both a polarization axis of the polar-orthogonally polarized light and a birefringence axis of the axisymmetric birefringent element.

The axisymmetric birefringent element can be made from a uniaxial crystal having an optical axis aligned with both the polarization axis and the chief rays. Birefringence is minimized along the optical axis of the uniaxial crystal. However, the axisymmetric birefringent element preferably exhibits a maximum birefringence difference between ordinary and extraordinary rays of at least 0.0005. Preferably, the axisymmetric birefringent element contributes optical power to the imaging system and increases a numerical aperture of the imaging system. The axisymmetric birefringent element can have an average refractive index substantially above an average refractive index of the other optical elements and a melting point substantially above an average melting point of the other optical elements.

The invention has wide applicability throughout the field of lithography and is useful for purposes of writing and inspection. The expanded range of materials made available for imaging at deep UV wavelengths can be use to reduce aberrations, increase numerical aperture or reduce diametrical dimensions, and accommodate higher power densities or extend service life of the optics.

### BRIEF DESCRIPTION OF THE DRAWING FIGURES

FIG. 1A is a diagram of an axial plane of an axisymmetric birefringent material in which an extraordinary ray is depicted with its oscillating polarization vector within the axial plane.

FIG. 1B is an end view of the axial plane of FIG. 1A showing the extraordinary ray, its oscillating polarization vector, and the birefringence axis of the axis of the axisymmetric birefringent material all in the axial plane.

FIG. 2A is a diagram of an axial plane of an axisymmetric birefringent material in which an ordinary ray is depicted within the axial plane while its oscillating polarization vector points into or out of the axial plane.

FIG. 2B is an end view of the axial plane of FIG. 2A showing the ordinary ray and the birefringence axis the axisymmetric birefringent material within the axial plane while its oscillating polarization vector extends normal to the axial plane.

FIG. 3A is an axial view of a radial polarization pattern in which electric field vectors extend within axial planes of the axisymmetric birefringent material.

FIG. 3B is a view of an axial plane taken along line 3B-3B of FIG. 3A showing a pair of extraordinary rays and their polarization vectors within the axial plane.

FIG. 4A is an axial view of an azimuthal polarization pattern in which electric field vectors extend normal to axial planes of the axisymmetric birefringent material.

FIG. 4B is a view of an axial plane taken along line 4B-4B of FIG. 4A showing a pair of ordinary rays with their polarization vectors extending in or out of the axial plane.

FIG. 5 is a diagram of a deep UV telecentric imaging system in which axisymmetric birefringent optics are located in telecentric object and image space.

FIG. 6 is a more detailed diagram of a microlithographic immersion objective in which the final glass optic is formed from sapphire.

FIG. 7 is an enlarged side view of the sapphire optic.

### DETAILED DESCRIPTION

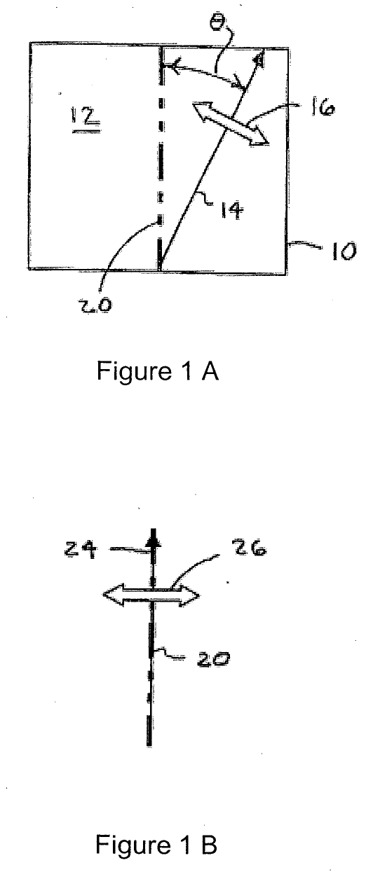

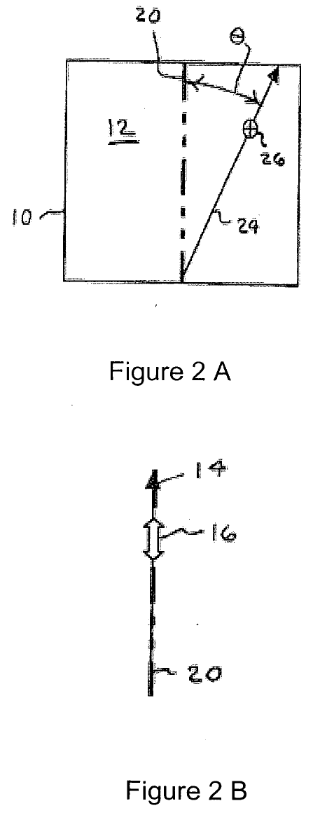

The refractive indices experienced by unpolarized rays propagating through birefringent materials are polarization dependent and divide the incoming rays into orthogonally polarized extraordinary and ordinary rays experiencing the different indices. FIGS. 1A, 1B, 2A, and 2B illustrate extraordinary and ordinary ray polarizations referenced to an axial plane 12 of an axisymmetric birefringent material 10, particularly a uniaxial birefringent crystal. As shown in FIGS. 1A and 1B, an oscillating electric field vector 16 of an extraordinary ray 14 lies in the axial plane 12, which includes both the ray 14 and a birefringence axis 20 of the axisymmetric birefringent material 10. For uniaxial birefringent crystals, the birefringence axis 20 is the optical axis of the uniaxial crystal along which birefringence is minimized. The electric field vector 16 extends perpendicular to the extraordinary ray 14 but within the axial plane 12.

As shown in FIGS. 2a and 2b, an oscillating electric field vector 26 of an ordinary ray 24 extends normal (perpendicular) to the same axial plane 12 as shown in FIGS. 1a and 1b. The electric field vector 26 points normal to both the ordinary ray 24 and the axial plane 12.

The electric field vector 16 of the extraordinary ray 14 is inclined to the birefringence axis 20 by the complement of the inclination angle “θ” of the extraordinary ray 14 to the birefringence axis 20. The electric field vector 26 of the ordinary ray 24 remains orthogonal to both the birefringence axis 20 and the axial plane 10 throughout a full range of inclinations of the ordinary ray 24 to the birefringence axis 20.

In the typical uniaxial birefringent crystal, the index of refraction experienced by the ordinary ray 24 remains constant through a full range of inclination angles with respect to the birefringence axis 20. The index of refraction experienced by extraordinary ray 14, however, varies as a continuous function of its inclination to the birefringence axis 20 in accordance with the following relationship:

$$\frac{1}{{n}^{2}} = \frac{{cos}^{2} θ}{{n}_{o}^{2}} + \frac{{sin}^{2} θ}{{n}_{e}^{2}}$$

where “θ” is the ray inclination angle to the birefringence axis 20, “n” is the refractive index exhibited by the extraordinary ray 14, “nₒ” is the ordinary refractive index, and “nₑ” is the extraordinary refractive index. At a zero degree inclination (θ=0), the extraordinary ray 14 experiences the same index as the ordinary ray 24. With increasing inclinations between zero and 90 degrees, the extraordinary ray 14 experiences progressively more of the extraordinary index nₑ and progressively less of the ordinary index nₒ. At a 90-degree inclination, the extraordinary ray 14 experiences the extraordinary index nₑ fully. The refractive index experienced by the ordinary ray 24 remains the ordinary refractive index nₒ, regardless of its inclination to the birefringence axis 20.

Thus, if a ray of unpolarized light passes through an axisymmetric birefringent optic, such as a uniaxial birefringent crystal, at an inclination to the birefringence axis 20, such a ray is split into the extraordinary and ordinary rays 14 and 24. The electric field vector of the unpolarized light includes polarization components corresponding to both the extraordinary and ordinary rays 14 and 24. The relative magnitudes of the two polarization components distinguish the relative intensities of the extraordinary and ordinary rays 14 and 24. The two rays 14 and 24 exit the axisymmetric birefringent material in different positions depending on the different refractive indices experienced by the two rays 14 and 24. Generally, the more the unpolarized ray is inclined to the birefringence axis, the greater the disparity between the exiting extraordinary and ordinary rays 14 and 24, because the refractive index n of the extraordinary ray 14 is a function of its inclination to the birefringence axis 20 as expressed by the above equation.

However, a ray of linearly polarized light having its electric field vector oriented either within an axial plane that includes the birefringence axis or normal to the same axial plane will not split into ordinary and extraordinary rays. Instead, the linear polarized ray will emerge either as an ordinary ray, if its electric field vector is oriented normal to the axial plane, or as an extraordinary ray, if its electric field vector is located within the axial plane. The electric field vector of linearly polarized light can also be oriented in a direction that intersects the axial plane at a non-normal angle, and this linearly polarized light is split between ordinary and extraordinary rays.

Thus, for a beam of light to avoid the birefringence effects of an axisymmetric birefringence material, such as a uniaxial birefringent crystal, each ray within the beam must be linearly polarized in a direction that either extends within an axial plane of the birefringence axis or extends normal to the same plane.

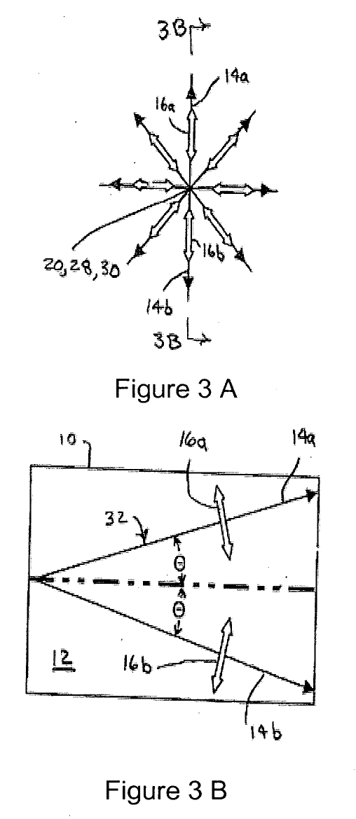

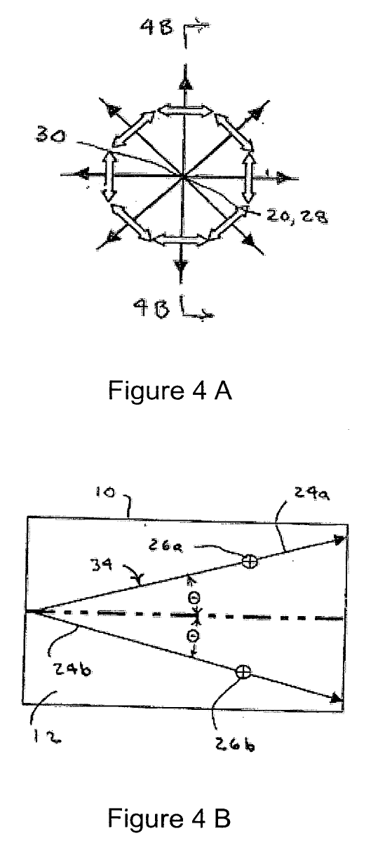

As shown in FIGS. 3A, 3B and 4A, 4B, an axially symmetric linear polarization pattern for a cone of light can meet this description, provided that the axis 28 of the cone is aligned with the birefringence axis 20 and the linear polarization of each ray either extends in the axial plane 12 of the ray or extends normal to the ray's axial plane 12. One axially symmetric linear polarization pattern (see FIGS. 3A and 3B), where the electric field vectors 16a and 16b lie together with their rays 14a and 14b in axial planes 12, is referred to as radial polarization, which is centered about a polarization axis 30. Another rotationally symmetric linear polarization pattern (see FIGS. 4A and 4B), where the electric field vectors 26a and 26b extend perpendicular to the axial planes 12 of their rays 24a and 24b, is referred to as azimuthal polarization, which is centered about the same polarization axis 30.

A cone 32 of radially polarized light exits the axisymmetric birefringent material 10 as a set of extraordinary rays- (e.g., 14a and 14b) that have undergone a wavefront distortion because of the variation in refractive index n as a function of ray angle θ. A cone 34 of azimuthally polarized light exits the axisymmetric birefringent material 10 as a set of ordinary rays (e.g., 24a and 24b) that undergo no such wavefront distortion. Normally, it is expected that azimuthally polarized light may be preferred to avoid wavefront distortions. However, the orderly wavefront distortion produced by radially polarized light may be of benefit for correcting other distortions in an imaging system or for other optical manipulations, such as alterations in the illumination system. Uniaxial birefringent crystals can have either positive or negative birefringence depending upon the relative magnitudes of the extraordinary nₑ and ordinary no refractive indices.

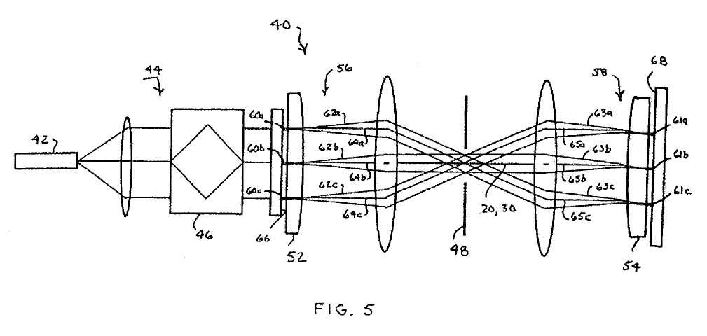

By arranging the axially symmetric polarization pattern conjugate to a pupil of a telecentric imaging system 40 as shown in FIG. 5, axisymmetric birefringent materials can be used to form optics, such as the optics 52 and 54, located in telecentric object and image space 56 and 58 while avoiding the effects of their natural birefringence. A light source 42, such as a an excimer laser operating below wavelengths of 300 nanometers (nm) and preferably around 157 nanometers (nm) wavelength, feeds an illuminator 44 that includes an axially symmetric polarizer 46 for producing a form of illumination that provides radial or azimuthal polarization in the pupil of the lens (viewed, for example, as an image of the aperture stop 48). The axially symmetric polarizer can take a variety of forms, starting from either polarized or unpolarized light. For example, diffractive optics, polarization-sensitive coatings, combinations of waveplates, and rotating slits can be used for this purpose. A polarization rotator intended for microlithographic imaging systems is disclosed in US Patent Application Publication 2002/0126380, which is hereby incorporated by reference.

Within telecentric object and image space 56 and 58, each object point 60a, 60b, and 60c of an object plane 66 or image point 61a, 61b, and 61c of an image plane 68 is associated with its own cone of light 62a, 62b, 62c or 63a, 63b, 63c having an axis formed by a chief ray 64a, 64b, 64c or 65a, 65b, 65c that extends both parallel to the intended polarization axis 30 of the polar-orthogonal polarization and the birefringence axis 20 of the axisymmetric birefringent optics 52 and 54. Each of the chief rays 64a, 64b, 64c, or 65a, 65b, 65c extends in the direction of the birefringence axis 30, and the other rays of each object or image point cone 62a, 62b, 62c, or 63a, 63b, 63c lie in axial planes that distinguish the polarizations of the ordinary and extraordinary rays. Accordingly, if the rotationally symmetric polarization of the illuminating radiation is conjugate to the pupil of the telecentric imaging system 40, then each object or image cone 62a, 62b, 62c, or 63a, 63b, 63c in telecentric object or image space 56 or 58 also has substantially the same axially symmetric polarization.

The ability to locate an axisymmetric birefringent optic 52 or 54 in telecentric object or image space 56 or 58 allows the initial or final optic of the telecentric imaging system 40 to be made from a uniaxial crystal or other robust axisymmetric birefringent material to better accommodate the higher power densities adjacent to the object or image planes 66 or 68. In reducing systems, such as most microlithographic projection systems, the highest power densities appear at the image plane 68, and the use of a more robust material such as sapphire can better accommodate these higher power densities without breaking down. Uniaxial crystals, such as sapphire and lanthanum fluoride, have higher refractive indices that can be exploited to increase the numerical aperture of the imaging system 50 or to reduce the size of other optical elements of the imaging system at a given numerical aperture. In addition, the axisymmetric birefringent optics 52 or 54 can be arranged to contribute optical power or to participate in a correction for aberrations within the imaging system 40.

Radially polarized light in the pupil can be equated to TM polarization on a ray-by-ray basis at the object or image planes 66 or 68, and azimuthally polarized light can be equated to TE polarization on a ray-by-ray basis at the same object or image planes 66 or 68. With increasing numerical apertures, the TM component has the initial effect of decreasing contrast. However, at even higher numerical apertures, such as over 1.2, the contrast for TM polarization increases but is phase reversed. TE polarization produces more consistent contrast but is more easily lost to reflections throughout the imaging system 40.

Radial and azimuthal polarizations can be converted between one another by rotating the electric field vectors of each ray through the same 90-degree interval. This could be accomplished with a waveplate that is not sensitive to its angular orientation about the optical axis. The locations in the imaging system for accomplishing this conversion may be limited, such as in a pupil, and it is preferred that the light impinging on the waveplate is collimated to rotate the polarizations evenly.

Leading up to this invention, a class of uniaxial crystals, which include sapphire, magnesium fluoride and lanthanum fluoride among others, was recognized as being sufficiently transmissive and robust for use in microlithographic imaging systems, but was also recognized as exhibiting disqualifying natural birefringence. Calcium fluoride exhibits some intrinsic birefringence at deep UV wavelengths deemed significant enough to require correction, but the known uniaxial birefringent crystals exhibit up to ten thousand times more natural birefringence. However, the confluence of symmetries described above avoids the undesirable effects of these crystals' birefringence. If properly combined with axial polarization symmetry together with appropriate propagating symmetries, such as found in telecentric space, axisymmetric birefringent materials can provide a significant expansion in the number of-materials that can be used in deep UV imaging systems.

The axisymmetric birefringent materials can be used for purposes including Aberration correction. Locations where the aberration corrections can be made include near the image plane 66 in the telecentric image space 56, near the object plane 68 in the telecentric object space 58, or in one or more intermediate telecentric spaces that may occur along the design. The axisymmetric birefringence elements can also be located in a pupil to which the axial polarization symmetry is conjugate. Although the birefringence exhibited by most uniaxial crystals is stronger as the inclination of the rays to the crystal axis increases, light rays with polar orthogonal polarization experience only one refractive index of the uniaxial crystal. That is, the light rays are not split according to their polarization between extraordinary and ordinary rays exiting the crystal.

Perhaps the most important use for uniaxial crystals may be as the final element in telecentric image space of microlithographic reducing systems, where power density is the highest and where a higher refractive index can potentially have the greatest effect on increasing the numerical aperture of the imaging system. Sapphire is particularly favored for use as the final solid optic in an immersive imaging system. Recent advances allow for the refractive index of a liquid immersion medium, such as water, to be increased by doping, and sapphire also has a high refractive index in the range of 1.9 (at the shorter UV wavelengths). Since numerical aperture is directly dependent upon the refractive index, the significant increase in index is expected to support a significant increase in a numerical aperture.

In addition, sapphire is a much more robust material than either calcium fluoride or fused silica, and it is believed that a sapphire can better withstand the high power densities occurring close to the image plane. The final optic can be formed as a single piece or in a stack. For example, the sapphire element could be formed as a plate, which is doubly immersed in a liquid medium for optically coupling the sapphire plate to both the image plane 68 and to an adjoining element having substantially more power, such as a hemispheric fused silica lens. Another version has the sapphire element formed as a hemispheric body that fits within a larger hemispheric body. In yet another version, the entire final optic used for immersion is made of sapphire, where the surface closest to the image plane is itself a plane but the opposite surface has significant power.

Magnesium fluoride as a uniaxial axis crystal material is favored for other locations because it has lower scattering than calcium fluoride. Other materials beyond uniaxial crystals may benefit from the invention if appropriately clocked or otherwise manipulated to exhibit axisymmetric birefringence symmetry.

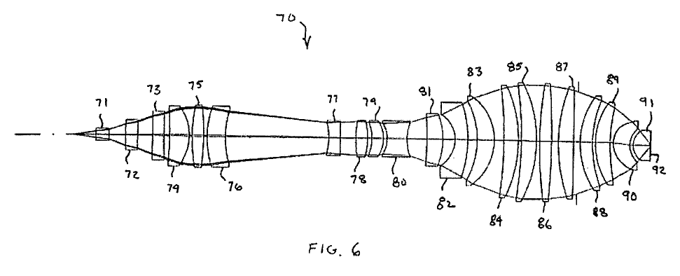

FIG. 6 depicts a detailed example of the invention as a microlithographic reducing objective 70 in which the final power-contributing optic 91 in telecentric image space is made of sapphire. Azimuthal illumination is intended for the reducing system so that TE polarized rays are oriented in axial planes of the sapphire optic. A table containing fabrication data for making the system follows:

| | Radius of Curvature | | | | | Aperture Diameter | | |
|---|---|---|---|---|---|---|---|---|
| Element | Front | | Back | | Thickness | Front | Back | Glass |
| object | infinity | | | | 22.7162 | | | |
| 71 | −40.0561 | CC | 21.4908 | CC | 12.7365 | 7.4107 | 10.9105 | ‘silica’ |
| | | | | | 17.3069 | | | |
| 72 | 954.8406 | CX | 791.7860 | CC | 12.1428 | 23.7916 | 29.4605 | ‘silica’ |
| | | | | | 15.9236 | | | |
| 73 | −3754.1127 | CC | 601.4940 | CC | 12.1379 | 41.7501 | 47.8864 | ‘silica’ |
| | | | | | 6.1041 | | | |
| 74 | −284.4443 | CC | −50.7060 | CX | 20.6634 | 51.6676 | 59.0022 | ‘silica’ |
| | | | | | 3.0261 | | | |
| 75 | 168.7964 | CX | −270.6818 | CX | 12.0000 | 61.6473 | 61.4689 | ‘silica’ |
| | | | | | 3.5931 | | | |
| 76 | 97.5798 | CX | 98.0335 | CC | 18.7039 | 59.7932 | 53.8375 | ‘silica’ |
| | | | | | 108.1750 | | | |
| 77 | −62.0900 | CC | 2259.6325 | CC | 12.0000 | 32.8036 | 33.7605 | ‘silica’ |
| | | | | | 15.5507 | | | |
| 78 | 107.0785 | CX | −79.6740 | CX | 12.0000 | 35.6821 | 35.2624 | ‘silica’ |
| | | | | | 4.4043 | | | |
| 79 | −46.6896 | CC | −34.4752 | CX | 12.0000 | 34.1886 | 34.9551 | ‘silica’ |
| | | | | | 3.9067 | | | |
| 80 | −30.7039 | CC | 51.0874 | CC | 20.9267 | 32.4286 | 35.2597 | ‘silica’ |
| | | | | | 21.0265 | | | |
| 81 | −310.6789 | CC | −70.7165 | CX | 17.2688 | 45.9368 | 51.8498 | ‘silica’ |
| | | | | | 12.7152 | | | |
| 82 | −31.4125 | CC | −120.7570 | CX | 13.0106 | 52.7285 | 75.3112 | ‘silica’ |
| | | | | | 9.5409 | | | |
| 83 | −86.9461 | CC | −57.6313 | CX | 17.4550 | 82.2229 | 89.8860 | ‘silica’ |
| | | | | | 3.2110 | | | |
| | | | | | | 107.4920 | | |
| | | | | | 6.7567 | | | |
| 84 | −420.6634 | CC | −136.3533 | CX | 14.8049 | 109.7404 | 113.0691 | ‘silica’ |
| | | | | | 3.0946 | | | |
| 85 | −399.6038 | CC | −134.1723 | CX | 15.9259 | 116.9303 | 119.0109 | ‘silica’ |
| | | | | | 3.1242 | | | |
| 86 | 412.1277 | CX | −732.9222 | CX | 12.6875 | 118.4501 | 117.7198 | ‘silica’ |
| | | | | | 4.0805 | | | |
| | | | | | | 115.8989 | | |
| | | | | | 3.0048 | | | |
| 87 | 169.4014 | CX | −5177.8893 | CX | 16.1549 | 112.3438 | 109.6434 | ‘silica’ |
| | | | | | 3.8541 | | | |
| | | | | | APERTURE | 106.7052 | | |
| | | | | | STOP | | | |
| | | | | | 3.0007 | | | |
| 88 | A(1) | | 123.0148 | CC | 12.5413 | 94.8412 | 88.6023 | ‘silica’ |
| | | | | | 3.0000 | | | |
| 89 | 76.9995 | CX | 187.7309 | CC | 14.8851 | 82.2109 | 74.9824 | ‘silica’ |
| | | | | | 3.1499 | | | |
| 90 | 26.1648 | CX | 24.0410 | CC | 15.5683 | 49.1664 | 35.0065 | ‘silica’ |
| | | | | | 3.0761 | | | |
| 91 | 18.9232 | CX | infinity | | 17.3203 | 29.0696 | 2.9984 | ‘sapphire’ |

| | | | | | | |
|---|---|---|---|---|---|---|
| 92 | infinity | infinity | 0.6372 | 2.9984 | 0.0707 | ‘fluid’ |

| | | |
|---|---|---|
| image | infinity | 0.0707 |

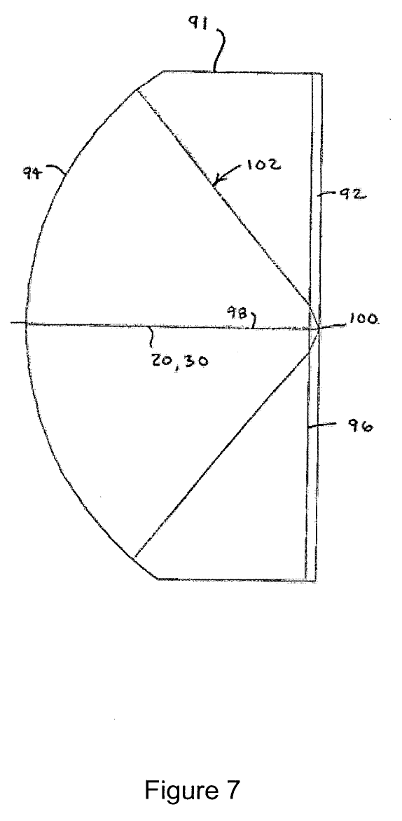

All dimensions are given in millimeters (mm). Thickness is the axial distance to the next surface. A positive radius in the table indicates that the center of curvature is to the right in the reducing system of FIG. 7. A negative radius indicates that the center of curvature is to the left. Image diameter is a paraxial value. The term ‘silica’ refers to fused silica, and the term ‘fluid’ refers to a high index fluid having a refractive index of 1.636. The higher refractive index of the sapphire (approximately 1.9 at the intended wavelength) allows the higher index fluid to be used for effecting a higher numerical aperture.

The aspheric surface A(1) is defined according to the following equation:

$$z = \frac{( curv ) {Y}^{2}}{1 + {( 1 - ( 1 + k ) {( curv )}^{2} {Y}^{2} )}^{\frac{1}{2}}} + ( A ) {Y}^{4} + ( B ) {Y}^{6} + ( C ) {Y}^{8} + ( D ) {Y}^{10} + ( E ) {Y}^{12} + ( F ) {Y}^{14} + ( G ) {Y}^{16} + ( H ) {Y}^{18} + ( J ) {Y}^{20}$$

where for the aspheric A(1), the following constants are applied:

| Constant | Value | Constant | Value | Constant | Value |
|---|---|---|---|---|---|
| curv | 0.01127912 | K | 0.000000 | A | 1.31802E−08 |
| B | 3.85765E−12 | C | 9.28100E−16 | D | −7.42309E−19 |
| E | −2.54519E−22 | F | −2.99644E−26 | G | 3.79801E−29 |
| H | 1.72294E−32 | J | −1.20006E−35 | | |

As shown in FIG. 7, the sapphire optic 91 has a curved entrance surface 94 and a planar exit surface 96 adjacent to the high index fluid 92. Chief rays (e.g., 98) of image points (e.g., 100) propagating through the sapphire optic 91 are nearly telecentric to align the polarization axis 30 of each cone 102 of polar-orthogonally polarized light with the birefringence (i.e., optical) axis 20 of the sapphire optic 91.

Although the invention refers to telecentric imaging systems, polar orthogonal polarizations, and axisymmetric birefringent materials, we mean for practical purposes nearly telecentric imaging systems, nearly polar orthogonal polarizations, and nearly axisymmetric birefringent materials, encompassing a range of variation within which the overall purposes of the invention are achieved. The specific tolerances involved will themselves vary with specific application requirements.

Although the invention has been described with respect to a limited number of embodiments, those of skill in the art will appreciate the many variations that are possible within the teaching of this invention. For example, instead of forming the axisymmetric birefringence optic from a simple uniaxial crystal, a combination of materials, including cubic crystals, collectively exhibiting an axisymmetric birefringence could be used.

What is claimed is:

1. A telecentric imaging system aligning polar-orthogonally polarized light with an axisymmetric birefringent element.

2. The telecentric imaging system of claim 1 in which the polar-orthogonally polarized light has a polarization axis about which electric field vectors are symmetrically arranged, the axisymmetric birefringent element has a birefringence axis about which birefringence is symmetrically arranged, and the polarization axis of the polar-orthogonally polarized light is aligned with the birefringence axis of the axisymmetric birefringent element.

3. The telecentric imaging system of claim 2 in which the axisymmetric birefringent element is located within a telecentric space in which chief rays of object or image points are aligned with both the polarization axis of the polar-orthogonally polarized light and the birefringence axis of the axisymmetric birefringent element.

4. The telecentric imaging system of claim 2 in which the telecentric imaging system is a reducing system, and the axisymmetric birefringent element is located within telecentric image space.

5. The telecentric imaging system of claim 4 in which the axisymmetric birefringent element is formed at least in part of sapphire.

6. The system of claim 1 in which the axisymmetric birefringent element separates polarized rays into extraordinary and ordinary rays, and the polar-orthogonally polarized light transmits through the axisymmetric birefringent element as substantially one or the other of the extraordinary and ordinary rays.

7. The telecentric imaging system of claim 6 in which the axisymmetric birefringent element exhibits a birefringence difference between ordinary and extraordinary rays of at least 0.0005.

8. The telecentric imaging system of claim 6 in which the polar-orthogonally polarized light is azimuthally polarized and transmits through the axisymmetric birefringent element as ordinary rays.

9. The telecentric imaging system of claim 6 in which the polar-orthogonally polarized light is radially polarized and transmits through the axisymmetric birefringent element as extraordinary rays.

10. The telecentric imaging system of claim 9 in which in which the axisymmetric birefringent element exhibits a refractive index that varies with inclinations of the extraordinary rays producing a wavefront alteration that compensates for one or more other wavefront alterations of the telecentric imaging system.

11. The telecentric imaging system of claim 1 in which the axisymmetric birefringent element contributes optical power to the telecentric optical system.

12. The telecentric imaging system of claim 11 in which the axisymmetric birefringent element is a solid optical element that exhibits an average refractive index that is higher than other solid optical elements of the telecentric imaging system.

13. The telecentric imaging system of claim 12 in which the axisymmetric birefringent element increases a numerical aperture of the telecentric imaging system.

14. The telecentric imaging system of claim 1 further comprising an illuminating system that arranges the polar-orthogonally polarized light conjugate to a pupil of the telecentric imaging system.

15. A deep UV imaging system comprising
an arrangement of optical elements for forming an image of an object,
an illuminator that produces deep UV polar-orthogonally polarized light,
at least one of the optical elements being an axisymmetric birefringent element exhibiting a birefringence difference between ordinary and extraordinary rays, and
the axisymmetric birefringent element being oriented with respect to the polar-orthogonally polarized light such that the-polar-orthogonally polarized light propagates through the axisymmetric birefringent element as substantially one or the other of the ordinary and extraordinary rays.

16. The imaging system of claim 15 including a pupil, and in which the illuminator produces the polar-orthogonally polarized light substantially conjugate to the pupil.

17. The imaging system of claim 16 in which the axisymmetric birefringent element is located in a telecentric space in which chief rays of object or image points extend substantially parallel to both a polarization axis of the polar-orthogonally polarized light and a birefringence axis of the axisymmetric birefringent element.

18. The imaging system of claim 17 in which the axisymmetric birefringent element is made from a uniaxial crystal having an optical axis aligned with both the polarization axis and the chief rays.

19. The imaging system of claim 18 in which birefringence is minimized along the optical axis of the uniaxial crystal.

20. The imaging system of claim 18 in which the axisymmetric birefringent element exhibits a birefringence difference between ordinary and extraordinary rays of at least 0.0005.

21. The imaging system of claim 17 in which the axisymmetric birefringent element contributes optical power to the imaging system.

22. The imaging system of claim 21 in which the axisymmetric birefringent element increases a numerical aperture of the imaging system.

23. The imaging system of claim 17 in which the axisymmetric birefringent element has an average refractive index substantially above an average refractive index of the other optical elements.

24. The imaging system of claim 17 in which the axisymmetric birefringent element has a melting point substantially above an average melting point of the other optical elements.
